(19) United States
(12) Patent Application Publication
(10) Pub. No.: US 2013/0044818 A1
(43) Pub. Date: Feb. 21, 2013

(54) Method And Apparatus For Video Coding Using A Special Class Of Measurement Matrices

(71) Applicants: Hong Jiang, Warren, NJ (US); Paul A. Wilford, Bernardsville, NJ (US); Raziel Haimi-Cohen, Springfield, NJ (US)

(72) Inventors: Hong Jiang, Warren, NJ (US); Paul A. Wilford, Bernardsville, NJ (US); Raziel Haimi-Cohen, Springfield, NJ (US)

(73) Assignee: ALCATEL-LUCENT USA INC., Murray Hill, NJ (US)

(21) Appl. No.: 13/213,743

(22) Filed: Aug. 19, 2011

(51) Int. Cl. H04N 7/28

(52) U.S. Cl. 375/240.22; 375/E07.209

(57) ABSTRACT

The embodiments relate to a method and apparatus for video coding using a special class of measurement matrices. The method includes generating, by the encoder, a measurement matrix including a first row having a sequence of values and at least one other row having a shifted version of the sequence of values for the first row, and obtaining, by the encoder, a set of measurements by applying the measurement matrix to the video data, where the set of measurements is coded data representing the video data.

### BACKGROUND

Compressive sensing is an emerging technology that acquires, compresses and transmits a set of measurements that represent coded video data. The essence of compressive sensing is to represent data by using compressive measurements. The compressive measurements are obtained by applying a measurement matrix to the video data to be represented. Therefore, the measurement matrix is a key part of compressive sensing.

Measurement matrices in compressive sensing are typically random measurement matrices such as randomly permutated Walsh-Hadamard matrices. Although such matrices are satisfactory in many situations, these types of matrices are not well suited for low complexity, real-time applications.

### SUMMARY

The embodiments relate to a method and apparatus for video coding using a special class of measurement matrices.

The method includes generating, by the encoder, a measurement matrix including a first row having a sequence of values and at least one other row having a shifted version of the sequence of values for the first row, and obtaining, by the encoder, a set of measurements by applying the measurement matrix to the video data, where the set of measurements is coded data representing the video data. The video data may be represented by a pixel vector including a number of pixel values.

The generating step may generate the measurement matrix of size M×N, where a value of M is a number of measurements included in the set, and a value of N is related to the number of pixel values included in the pixel vector. Also, a number of values in the sequence of values may correspond to the value of N. Furthermore, the value of N may be based on the number of pixels included in the pixel vector such that N is equal to 2^{K}−1, where K is any positive integer.

In one embodiment, the generating step increases the number of pixel values to include at least one dummy value until the number of pixel values satisfies 2^{K}−1, where K is any positive integer and the generates the sequence of values based on the increased number of pixel values.

In one embodiment, the generating step generates the sequence of values for the first row based on a linear feedback shift register. The generating step generates the sequence of values by selecting a polynomial based on the number of pixels included in the pixel vector and configuring a linear feedback shift register based on the selected polynomial, where the sequence of values is generated using the configured feedback shift register. Also, the generating step generates the at least one other row by shifting the sequence of values of the first row by one or more values.

In one embodiment, the generating step may include generating the measurement matrix to have N rows and N columns, where a value of N is related to the length of the pixel vector. The generating step further includes selecting M rows from the N rows based on a figure of merit value for said selected M rows, where a value of M corresponds to the number of measurements included in the set and M is less than N.

The method may further include transmitting, by the encoder, the set of measurements and measurement matrix information, where the measurement matrix information indicates information about the measurement matrix. The measurement matrix information includes at least one of information indicating a size of the measurement matrix, information indicating initial values of a shift register, information indicating a selected primitive polynomial, information indicating a type of shift of the at least one other row, and information indicating a type of value for the measurement matrix.

According to another embodiment, the method includes receiving, by an decoder, a set of measurements, where the set of measurements is coded data representing video data, and the video data is a pixel vector including a number of pixel values. The method further includes obtaining, by the decoder, a measurement matrix that was applied to the pixel vector at an encoder, the measurement matrix including a first row having a sequence of values and at least one other row having a shifted version of the sequence of values, and reconstructing, by the decoder, the video data based on the set of measurements and the obtained measurement matrix.

The measurement matrix has size M×N, a value of M corresponds to a number of measurements included in the set and a value of N is related to the number of pixel values included in the pixel vector. Also, a number of values in the sequence of values corresponds to the value of N. Further, the value of N is based on the number of pixels included in the pixel vector such that N is equal or less than 2^{K}−1, where K is any positive integer.

The shifted version of the sequence of values for the at least one other row includes the sequence of values of the first row that have been shifted by one or more values.

The receiving step may receive measurement matrix information, where the measurement matrix information indicates information about the measurement matrix, and the obtaining step obtains the measurement matrix based on the measurement matrix information. The measurement matrix information includes at least one of information indicating a size of the measurement matrix, information indicating initial values of a shift register, information indicating a selected primitive polynomial, information indicating a type of shift of the at least one other row, and information indicating a type of value for the measurement matrix.

The reconstruction step modifies the measurement matrix by adding additional rows to the measurement matrix to form a square matrix, and the reconstruction step reconstructs the video data using the square matrix.

The apparatus includes an encoder configured to generate a measurement matrix including a first row having a sequence of values and at least one other row having a shifted version of the sequence of values for the first row, and configured to obtain a set of measurements by applying the measurement matrix to the video data, where the set of measurements is coded data representing the video data.

The encoder generates the measurement matrix of size M×N, and a value of M is a number of measurements included in the set, and a value of N is related to the number of pixels included in the pixel vector. Also, a number of values in the sequence of values correspond to the value of N. Further, the value of N is based on the number of pixels included in the pixel vector such that N is equal to 2^{K}−1, where K is any positive integer.

In one embodiment, the encoder increases the number of pixel values to include at least one dummy value until the number of pixel values satisfies 2_{K}−1, where K is any positive integer and the generates the sequence of values based on the increased number of pixel values.

The encoder generates the sequence of values for the first row based on a linear feedback shift register. The encoder generates the sequence of values by selecting a polynomial based on the number of pixels included in the pixel vector and configuring a linear feedback shift register based on the selected polynomial, where the sequence of values is generated using the configured feedback shift register. The encoder generates the at least one other row by shifting the sequence of values of the first row by one or more values.

In one embodiment, the encoder is configured to generate the measurement matrix to have N rows and N columns, where a value of N is related to the length of the pixel vector. Also, the encoder is configured to select M rows from the N rows based on a figure of merit value for said selected M rows, where a value of M corresponds to the number of measurements included in the set and M is less than N.

The encoder is configured to transmit the set of measurements and measurement matrix information, where the measurement matrix information indicates information about the measurement matrix. The measurement matrix information includes at least one of information indicating a size of the measurement matrix, information indicating initial values of a shift register, information indicating a selected primitive polynomial, information indicating a type of shift of the at least one other row, and information indicating a type of value for the measurement matrix.

The apparatus includes a decoder configured to receive a set of measurements, where the set of measurements is coded data representing video data, and the video data is a pixel vector including a number of pixel values. The decoder is configured to obtain a measurement matrix that was applied to the pixel vector at an encoder, where the measurement matrix includes a first row having a sequence of values and at least one other row having a shifted version of the sequence of values. The decoder is configured to reconstruct the video data based on the set of measurements and the obtained measurement matrix.

The measurement matrix has size M×N, and a value of M corresponds to a number of measurements included in the set and a value of N is related to the number of pixel values included in the pixel vector. Also, a number of values in the sequence of values corresponds to the value of N. Further, the value of N is based on the number of pixels included in the pixel vector such that N is equal to 2^{K}−1, where K is any positive integer. The shifted version of the sequence of values for the at least one other row includes the sequence of values of the first row that have been shifted by one or more values.

The decoder is configured to receive measurement matrix information, where the measurement matrix information indicates information about the measurement matrix. The decoder is configured to obtain the measurement matrix based on the measurement matrix information. The measurement matrix information includes at least one of information indicating a size of the measurement matrix, information indicating initial values of a shift register, information indicating a selected primitive polynomial, information indicating a type of shift of the at least one other row, and information indicating a type of value for the measurement matrix. The decoder modifies the measurement matrix by adding additional rows to the measurement matrix to form a square matrix, and the decoder reconstructs the video data using the square matrix.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present disclosure, and wherein:

FIG. 1 illustrates a communication network according to an embodiment;

FIG. 2 illustrates components of a source device and destination device according to an embodiment;

FIG. 3 illustrates a method for generating a measurement matrix according to an embodiment;

FIG. 4 illustrates a linear feedback shift register according to an embodiment;

FIG. 5 illustrates a method of encoding acquired video data using compressive measurements according to an embodiment; and

FIG. 6 illustrates a reconstruction process according to an embodiment.

### DETAILED DESCRIPTION OF EXAMPLE EMBODIMENTS

Various embodiments will now be described more fully with reference to the accompanying drawings. Like elements on the drawings are labeled by like reference numerals.

As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The embodiments will now be described with reference to the attached figures. Various structures, systems and devices are schematically depicted in the drawings for purposes of explanation only and so as not to obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. To the extent that a term or phrase is intended to have a special meaning, i.e., a meaning other than that understood by skilled artisans, such a special definition will be expressly set forth in the specification that directly and unequivocally provides the special definition for the term or phrase.

Co-pending application Ser. No. 12/894,807 filed Sep. 30, 2010, co-pending application Ser. No. 12/894,855 filed Sep. 30, 2010, co-pending application Ser. No. 12/894,757 filed Sep. 30, 2010, co-pending application Ser. No. 13/182,856 filed Jul. 14, 2011 and co-pending application Ser. No. ______ filed ______ [attorney docket No. 29250-002541], all of which are incorporated by reference in their entirety, disclose an apparatus and method in which video data is encoded and decoded using compressive sensing. For instance, in compressive sensing, video data having a temporal structure (e.g., original video structure, video cube, or video, tube) represented by a vector (e.g., x₁, . . . , x_{N}) of pixel values is coded by applying a measurement matrix to the pixel vector in order to generate a set of measurements, where the number of measurements is less than the number of pixel values included in the pixel vector. The set of measurements is then transmitted to a decoder, and the decoder reconstructs the video data from the set of measurements using the same measurement matrix. Embodiments of the present disclosure provide a special class of measurement matrices for use in compressive sensing.

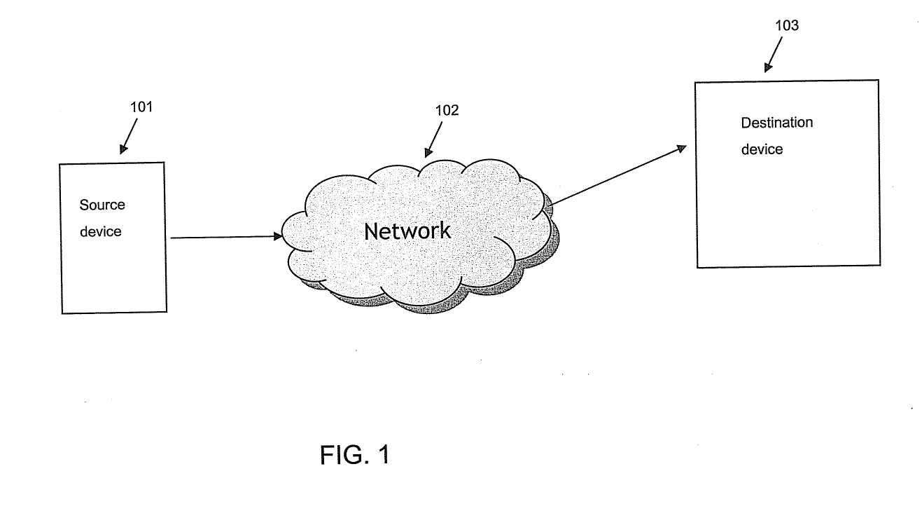

FIG. 1 illustrates a communication network according to an embodiment. The communication network includes at least one source device 101 for acquiring, encoding and/or transmitting video data, a network 102 supporting a video transmission application, and at least one destination device 103 for receiving, decoding and/or displaying the received video data. The network 102 may be any known transmission, wireless or wirelined, network. For example, the network 102 may be a wireless network which includes a radio network controller (RNC), a base station (BS), or any other known component necessary for the transmission of video data over the network 102 from one device to another device. The video transmission application part of the network 102 may include Digital Video Broadcasting—Handheld (DVB-H), Digital Video Broadcasting—Satellite services to Handhelds (DVB-SH), Long, Term Evolution (LTE) or evolved Multimedia Broadcast and Multicast Services (eMBMS), for example. One device may transmit video information to another device via a dedicated or shared communication channel.

The source device 101 may be any type of device capable of acquiring video data and encoding the video data for transmission via the network 102 such as personal computer systems, camera systems, mobile video phones, smart phones, or any type of computing device that may connect to the network 102, for example. Each source device 101 includes at least one processor and a memory for storing instructions to be carried out by the processor. The acquisition, encoding, transmitting or any other function of the source device 101 may be controlled by at least one processor. However, a number of separate processors may be provided to control a specific type of function or a number of functions of the source device 101. The implementation of the processor(s) to perform the functions described below is within the skill of someone with ordinary skill in the art.

The destination device 103 may be any type of device capable of receiving, decoding and displaying video data such as personal computer systems, mobile video phones, smart phones or any type of computing device that may receive video information from the network 102. The receiving, decoding, and displaying or any other function of the destination device 103 may be controlled by at least one processor. However, a number of separate processors may be provided to control a specific type of function or a number of functions of the destination device 103. The implementation of the processor(s) to perform the functions described below is within the skill of someone with ordinary skill in the art.

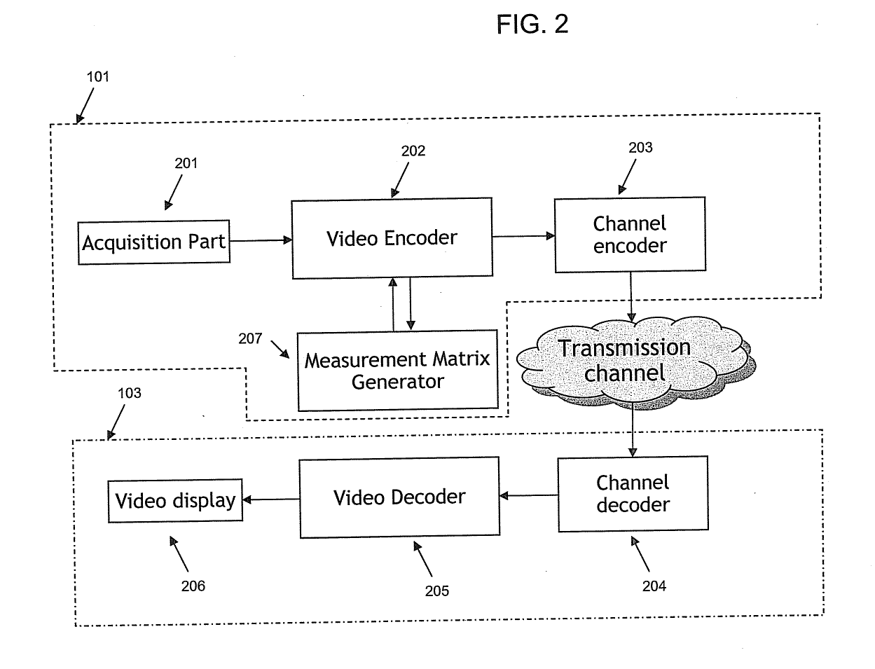

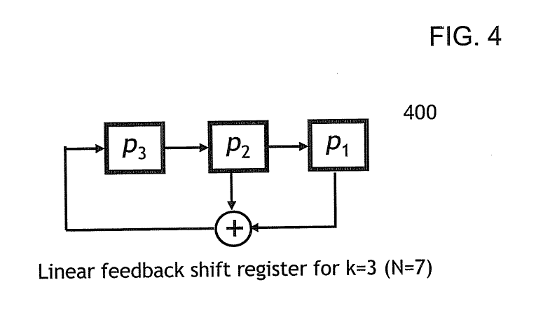

FIG. 2 illustrates components of the source device 101 and the destination device 103 according to an embodiment. For example, the source device 101 includes an acquisition part 201, a measurement matrix generator 207, a video encoder 202, and a channel encoder 203. Also, the source device 101 may include a linear feedback shift register, which is further explained in FIG. 4. In addition, the source device 101 may include other components that are well known to one of ordinary skill in the art. Referring to FIG. 2, the acquisition part 201 acquires video data from a video camera component included in the source device 101 or connected to the source device 101. Also, the source device 101 may acquire video data from any type of computer-readable medium such as optical disks and/or any type of memory storage unit. The acquisition of video data may be accomplished according to any well known methods.

The video encoder 202 encodes the acquired video data using compressive measurements to generate a set of measurements, which represents the encoded video data. The acquired video data may be represented by a pixel vector having a plurality of pixel values. For example, the video encoder 202 may receive a measurement matrix (or referred to as set of measurement bases) from the measurement matrix generator 207 and apply the measurement matrix to the original video data in its original form or a modified temporal structure such as video cubes, tubes or any type of video structure to generate a set of measurements to be stored on a computer-readable medium such as an optical disk or storage unit or to be transmitted to the destination device 103. It is also possible to combine the functionality of acquisition part 201 and the video encoder 202 into one unit, as described in application Ser. No. 12/894,855. Also, it is noted that the acquisition part 201, the video encoder 202, the channel encoder 203, and/or the measurement matrix generator 207 may be implemented in one, two or any number of units.

Using the set of measurements, the channel encoder 203 codes the measurements to be transmitted in the communication channel. For example, the measurements are quantized to integers. The quantized measurements are packetized into transmission packets. The transmission sequence including the quantized measurements may also include other information such as measurement matrix information that identifies the measurement matrix generated by the measurement matrix generator 207 so that the destination device 103 may reconstruct the measurement matrix based on the measurement matrix information. The details of the measurement matrix information are further discussed below. Additional parity bits are added to the packets for the purpose of error detection and/or error correction. It is well known in the art that the measurements thus coded can be transmitted in the network 102. Next, the source device 101 may transmit the encoded video data to the destination device via the communication channel of the network 102. The encoded video data as well as the measurement matrix information and other additional information such as assignment information may be transmitted in the network 102 via a plurality of datagrams, which is explained with reference to co-pending application Ser. No. ______ [attorney docket No. 29250-002541].

The destination device 103 includes a channel decoder 204, a video decoder 205, and a video display 206. The destination device 103 may include other components that are well known to one of ordinary skill in the art.

The channel decoder 204 decodes the data received from communication channel. For example, the data from the communication channel is processed to detect and/or correct errors from the transmission by using the parity bits of the data. The correctly received packets are unpacketized to produce the quantized measurements made in the video encoder 202. It is well known in the art that data can be packetized and coded in such a way that a received packet at the channel decoder 204 can be decoded; and after decoding, the packet can be (1) either corrected, free of transmission error, or (2) the packet can be found to contain transmission errors that cannot be corrected, in which case the packet is considered lost. In other words, the channel decoder 204 is able to process a received packet to attempt to correct errors in the packet, and to determine whether or not the processed packet has errors, and to forward only the correct measurements from an error free packet to the video decoder 205.

The video decoder 205 reconstructs the video data based on the correctly received set of measurements and the measurement matrix that was applied at the encoder. The video decoder 205 may obtain the identity of the measurement matrix from the measurement matrix information included in the transmission sequence from the source device 101. For example, based on the measurement matrix information, the video decoder 205 may obtain the identity of the measurement matrix that was applied to the video data at the source device 101. However, the embodiments encompass any type of means for obtaining the measurement matrix at the destination device 103. For example, the measurement matrix may be stored in a storage unit of the destination device. As such, the video decoder 205 would obtain the measurement matrix from the storage unit for use in compressive sampling. Then, the video decoder 205 reconstructs the video data based on the set of measurements and the obtained measurement matrix in a manner described below and in application Ser. Nos. 12/894,855, 12/894,757, 12/894,807, ______ [attorney docket No. 29250-002541] and 13/182,856.

The video display 206 may be a video display screen of a particular size. The video display 206 may be included in the destination device 103, or may be connected (wirelessly, wired) to the destination device 103. The destination device 103 displays the decoded video data on the video display 206 of the destination device 103 according to the original display resolution or a resolution different from the original display resolution, as described in application Ser. No. 12/894,807 and/or application Ser. No. 13/182,856. Also, it is noted that the video display 206, the video decoder 205 and/or the channel decoder 204 may be implemented in one or any number of units.

According to embodiments, the measurement matrix generator 207 generates a special class of measurement matrix to be used in the encoding and decoding process.

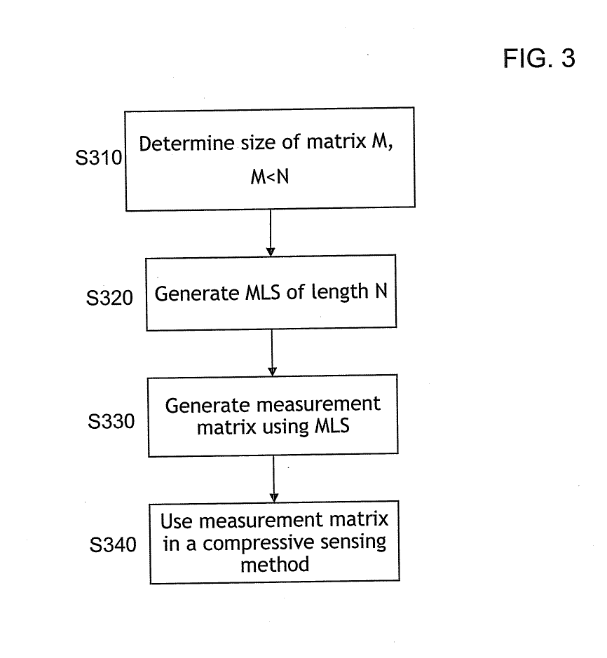

FIG. 3 illustrates a method for generating a measurement matrix according to an embodiment.

In step S310, the measurement matrix generator 207 determines a size M×N of the measurement matrix. A value of M is determined according to the number of measurements to be included in the set of measurements, and a value of N is related to the number of pixels included in the vector and determined such that a value of N is a power of two minus one. For example, the value of N may correspond to the number of pixels included in the vector such that a value of N is equal to 2^{k}−1, where a value of K is any positive integer.

The number of measurements M corresponds to the number of rows of the measurement matrix. In other words, each row of the measurement matrix produces a measurement. The number of pixels in a pixel vector, or the length of the pixel vector, N, is the number of columns in the measurement matrix. Therefore, the dimension of the measurement matrix is M×N, where a value of M is the number of measurements, and a value of N is related to the length of the pixel vector subject to the constraint of 2^{k}−1, where a value of K is any positive integer.

If the number of pixels in the video data (e.g., a video cube, or video tube) is not equal to 2^{k}−1 for any integer value of K, the pixel vector is appended with at least one dummy value such as a zero or any other type of dummy value so that its length N is increased to equal 2^{k}−1 for a some positive integer K. In other words, a pixel vector consists of the pixel values from the video data (e.g., video cube or video tube), and possibly a sequence of zeros so that its length is exactly 2^{k}−1 for some integer of K. If the pixel vector is appended with zeros (or other type of dummy value), the zeros may be placed in any location of the pixel vector. For example, the zeros may be placed towards the beginning, middle or end of the pixel vector. Further, the zeros may be distributed throughout the pixel vector in any type of manner.

In step S320, the measurement matrix generator 207 generates a maximum length sequence of values. The maximum length sequence of values is of length N, where a value of N is the same value N described above. Each value of the maximum length sequence may be a binary value of 0 or 1. The measurement matrix generator 207 generates the maximum length sequence based on a selected primitive polynomial over the field of the integers modulo 2. and a linear feedback shift register that has been configured based on the selected primitive polynomial, as further described below. The choice of the field of integers modulo 2 results in binary maximum length sequence, i.e. sequences the terms of which get only two values. However, for some application a different basis field may be preferred. While the description here is for binary maximum length sequences, The description of the invention applies in the same way to maximum length sequence which get their values in any finite field.

For example, based on the value of N, the measurement matrix generator 207 selects a primitive polynomial. Table 1 below illustrates three primitive polynomials according to an embodiment.

TABLE 1

| Value of K | Polynomial |
|---|---|
| 2 | 1 + x + x² |
| 3 | 1 + x + x³ |
| 4 | 1 + x + x⁴ |

Although Table 1 only illustrates three different primitive polynomials, the embodiments include any number of primitive polynomials. For example, for values of K after 4, the primitive polynomials are increased to the next order as the value of K increases. The value of K is determined from the constraint N≦2^{k}−1. As such, after the value of N is determined, as described above, the value of K may be obtained. Therefore, in one embodiment, if the value of N is determined as 7, the value of K is 3, and the measurement matrix generator 207 selects the primitive polynomial of 1+x+x³. Primitive polynomials of any order K can be obtained according to methods that are well known to one of ordinary skill in the art.

FIG. 4 illustrates a linear feedback shift register 400 that implements the selected polynomial and generates the maximum length sequence of length N according to an embodiment.

In FIG. 4, the linear feedback shift register 400 is configured according to the polynomial corresponding to K=3 of Table 1 (e.g., 1+x+x³), which is for N=7 and K=3. However, the embodiments encompass a linear feedback shift register that has been configured according to any type of primitive polynomial. The linear feedback shift register 400 includes a plurality of stages such as stage p₁, stage p₂ and stage p₃. Because the polynomial of K=3 is used in this example, the output of the stage p₂ is added to the output of the stage p₁ (modulo 2), and the result of the addition is provided to the input of the stage p₃. Configuration of a linear feedback shift register for a given primitive polynomial of any order K is well known to one of ordinary skill in the art.

In order to, generate the maximum length sequence of length N, the measurement matrix generator 207 initially places a value of 0 or 1 in each of the stage p₁, stage p₂ and stage p₃. However, the initial values of the stage p₁, stage p₂ and stage p₃ must contain at least one non-zero value. The initial values of the stage p₁, stage p₂ and stage p₃ form the last three values of the maximum length sequence of length N. Below is an example of a maximum length sequence of length N, where the value of N is 7.

Maximum length sequence=0 0 1 0 1 1 1

In this example, the value of 1 is placed in each of the stage p₁, stage p₂ and stage p₃. As such, the last three values of the maximum length sequence is “1 1 1.” Then, the measurement matrix generator 207 controls the linear feedback shift register 400 to add the value of 1 from the stage p₁ with the value of 1 from the stage p₂, which results in a value of 0, and this value of 0 is placed as a new value in the stage p₃. The previous value of the stage p₃ (i.e., “1”) is transferred to the stage p₂ and the previous value of the stage p₂ (i.e., “1”) is transferred to the stage p₁. The new value of “0” corresponds to the next value of the maximum length sequence, which is located to the left of the values of “1 1 1.” Now, the current values of the linear feedback shift register 400 is 0 1 1. This process is repeated until each of the values for the maximum length sequence is generated. The operation of linear feedback shift register is well known to a person having ordinary skill in the art.

In step S330, the measurement matrix generator 207 generates the measurement matrix based on the maximum length sequence. For example, the measurement matrix generator 207 may generate the measurement matrix to include a first row having the maximum length sequence, and the other rows having circularly shifted versions of the maximum length sequence. For example, Table 2 illustrates the measurement matrix having size M×N with the maximum length sequence of 7 and the value of M being 7.

TABLE 2

| | | | | | | |
|---|---|---|---|---|---|---|
| 0 | 0 | 1 | 0 | 1 | 1 | 1 |
| 1 | 0 | 0 | 1 | 0 | 1 | 1 |
| 1 | 1 | 0 | 0 | 1 | 0 | 1 |
| 1 | 1 | 1 | 0 | 0 | 1 | 0 |
| 0 | 1 | 1 | 1 | 0 | 0 | 1 |
| 0 | 0 | 1 | 1 | 1 | 0 | 0 |
| 1 | 0 | 0 | 1 | 1 | 1 | 0 |

As shown above, the second row through the seventh row of the measurement matrix are shifted variations of the maximum length sequence of 0 0 1 0 1 1 1. In particular, the values of the second row are the values of the first row, which have been circularly shifted one place to the right, with the first value of the second row being the last value of the first row. Each of the other rows of the matrix is shifted in the same manner with respect to the previous one. In this example, each of the values of the measurement matrix is 0 or 1.

In another embodiment, the measurement matrix generator 207 generates the measurement matrix to have values of 1 or −1 based on the maximum length sequence. For example, the measurement matrix generator 207 converts the values of 1 or 0 in the maximum length sequence to −1 or 1. The value of −1 corresponds to 1 and the value of 0 corresponds to 1. Table 3 illustrates an example of this embodiment.

TABLE 3

| | | | | | | |
|---|---|---|---|---|---|---|
| 1 | 1 | −1 | 1 | −1 | −1 | −1 |
| −1 | 1 | 1 | −1 | 1 | −1 | −1 |
| −1 | −1 | 1 | 1 | −1 | 1 | −1 |
| −1 | −1 | −1 | 1 | 1 | −1 | 1 |
| 1 | −1 | −1 | −1 | 1 | 1 | −1 |
| −1 | 1 | −1 | −1 | −1 | 1 | 1 |
| 1 | −1 | 1 | −1 | −1 | −1 | 1 |

The embodiments encompass other variations of Table 2 and Table 3. For example, a measurement matrix may be obtained similarly as in Table 2 and Table 3, with the first row being a maximum length sequence. Then, the next row is obtained from the first row as with Table 2 or 3, however, the entries are shifted S places to the right, where S is a positive integer 1≦S<N. In general, each row is obtained from the previous row by shifting S places to the right.

More generally, after generating the measurement matrix as in Table 2 or Table 3, that is, where each row of the measurement matrix is shifted left by one with respect to the previous one, the rows may be reordered according to some permutation of the row numbers. Such a permutation may be reselected or randomly generated. In Table 2 and Table 3, the number of rows, M, is same as the number of columns, N, but in general, the number of rows may be smaller than the number of columns, e.g., M<N. For example, a matrix as in Table 2 or Table 3 may be generated, the rows may be reordered the rows according to some permutation of the row numbers and then select the first M rows as the rows of the measurement matrix. In yet other embodiments, the matrix may be scaled by multiplying the matrix entries by a constant. For example, such constants may be selected so that the sum of squares of the entries in each column, after scaling, is one.

When the number of rows is smaller than the number of columns, the effectiveness of the measurement matrix for the purposes of compressive sensing depends on the choice of rows to be used. In the following, a general approach is described for assessing the quality of a matrix generated from a maximum length sequence and for selecting the rows in an effective way. For the purpose of this discussion, the maximum length sequence w(n) is assumed to have the values of −1 or 1 and that it is infinite with a period of N. For simplicity of notation, the indices of the matrix and vector entries begin with 0, thus the first column and first row of a matrix are column 0 and row 0, respectively.

Let W be an N×N matrix generated from the maximum length sequence as in table 3. Then wᵢⱼ=w(j−i).

The sensing matrix A is created by selecting M rows from W. Suppose the indices of those rows are s=[s(0), . . . , s(M−1)]. Then the entries of the sensing matrix A are given by: aᵢⱼ=wₛ₍ᵢ₎ⱼ=w(j−s(i). s is denoted “the row indices vector.”

The partial sums corresponding to s is defined by σ(n,s)=w(n−s(0))+w(n−s(1))+ . . . +w(n−s(M−1)) for n=0, . . . , N−1. Conceptually, the sequence σ(n,s) is obtained by creating N shifted copies of the sequence {w(n)}, where the 1-th copy (i=0, . . . , M−1) is shifted to the right by s(i). Generally, the sensing matrix A is good if there are few entries of large magnitude in the partial sums sequence σ(n,s) and if the magnitude of those entries is relatively small. To make this statement more precise, the sequence d(n) is defined to be the partial sums magnitudes, |σ(n, s)|, sorted in decreasing order. Then, a figure of merit is defined for the particular row selection, R(s), based on several of the first entries in d(n). In one embodiment, the figure of merit is defined as the sum of squares of the first L entries: R(s)=d d dR(s) are considered to be better. However, other embodiments may use other figures of merit. In the following description, it is assumed that a lower figure of merit indicates better row indices selection, but other conventions may be used equally well.

As an example consider the sequence of length 7 in the first row Table 3: 1, −1, −1, 1, −1, −1, −1. Suppose the row indices vector is s=[0,1,3]. Then in order to compute σ(n,s) we need to add the first, second and fourth row in Table 3, getting: −1, 1, −1, 1, 1, −3, −1. The corresponding d(n) sequence is obtained by taking the absolute value and sorting in a decreasing order, hence it is: 3, 1, 1, 1, 1, 1, 1. If we use L=2 then the figure of merit, R(s) is d²(0)+d²(1)=3²+1²=10.

In some embodiments the figure of merit is used as an aid for random selection of rows. For example, a row indices vector, s, is chosen in a random fashion and the figure of merit, R(s) is computed. If the figure of merit is below a threshold, the row indices vector is accepted; otherwise it is discarded, another row indices vector is chosen in a random fashion and evaluated in the same way. The process continues until a vector is found for which the figure of merit is below the threshold. Alternatively, one generates several row selection vectors in a random fashion, compute the figure of merit for each of them and select the one with the best figure of merit.

In other embodiments, a search algorithm is used to find a near optimal row selection vector, in the sense of having a better figure of merit, given a specified number of rows, M. Alternatively, a search algorithm may be given a threshold for the figure of merit as input and produce as output the minimal value M for which there is a row selection vector with a figure of merit below the threshold, as well as a near optimal row selection vector of dimension M with a figure of merit below the threshold. There are many variants of these algorithms. We present here some examples to illustrate the concept.

Some definitions are provided below: if s is a row indices vector, then s shifted by n, denoted s+n, is the row indices vector whose entries are shifted by n (modulo N) relatively to the to the corresponding entries in s: s+n=(s(0)Θn, . . . , s(M−1)Θn), where Θ indicates addition modulo N. If s′ and s″ are two row indices vectors, then their union, denoted s′vs″, is the row indices vector which contains the rows of both s′ and s″. A candidate is a triplet (s,σ(.,s),R(s)) comprising of a particular row selection vector s and the partial sum sequence and figure of merit corresponding to this vector. The candidate is of dimension m if its row selection vector is of dimension m.

A “candidates list” is a sequence of candidates of the same dimension, in an increasing order of figure of merit, thus the first candidate in the list has the best figure of merit and the last candidate in the list has the worst figure of merit. The dimension of a candidate list to indicate the dimension of the candidates in the list. The length of the list denotes the number of candidates in it. If S′ and S″ are two candidate lists of dimension m′, m″, respectively, then the Q-capped cross product of the lists, denoted (S′ΘS″)_{Q}, is the candidates list S of dimension m′+m″, whose candidates have row indices vectors of the form s′v(s″+k), s′εS′, s″εS″, and 0<k<N. Of all such possible candidates, (S′ΘS″)_{Q} contains up to Q candidates with the best figures of merit. If Q was set to infinity, or equivalently, to a very large number, then (S′ΘS″)_{Q} would contain all possible candidates of the form s′v(s″+k), s′εS′, s″εS″, and 0<k<N. This would make the list too long for practical implementation. The capping retains the Q best candidates, where Q is selected to be a reasonable value according to the memory and processing power available for the computation. S=(S′ΘS″)_{Q} can be generated in the following steps:

1. Initialize: Set S to be the empty sequence.

2. For each s′εS′, s″εS″, and 0<k<N do:
a. Compute s″+k. If s′ has some row indices in common with s″+n skip the steps b-f.
b. Compute s=s′v(s″+k). If S already contains a candidate with s as its row indices vector, skip steps c-f.
c. Compute σ(n,s) by adding σ(n,s′)+σ(nΘk,s″) for 0≦n<N.
d. Calculate d(0), . . . , d(L−1) and from them calculate the figure of merit, R(s).
e. If S is of length Q:
   i. If R(s) is greater than the figure of merit of the last candidate in S skip step f.
   ii. Else, remove the last candidate from S.
f. Insert the candidate (s,σ(.,s),R(s)) into S, into a place that will keep the figures of merit in the list in an increasing order.

The search algorithm builds candidate lists of increasing dimension, until it reaches the desired dimension M. At that point the algorithm selects the row indices vector of the first candidate in the list. The building of the lists is done by successively creating Q-capped cross products of previously computed candidates lists. If Q was set to infinity, or equivalently, to a very large number, then each list would contain all possible candidates of the dimension of the list and the search would be optimal, but computationally intractable. Capping the list to the Q best candidates “prunes” the search tree, making the search suboptimal, yet tractable. The following is an outline of the steps of a possible search. In this search algorithm, Sⱼ is a list of up to Q candidates of dimension 2^{j}, which is generated by a Q-capped cross product of Sⱼ₋₁ with itself. At the j-th iteration of step 2 the set S* is of dimension b₂2⁰+ . . . +bⱼ2^{j} and is constructed by Q-capped cross products of the lists Sₖ, 0≦k≦j for which bₖ=1.

1. Initialize:
a. Set s:=[0], the one dimensional row indices vector which selects the first row. Set the partial sums sequence corresponding to s to be σ(n,s):=w(n). Compute R(s).
b. Set So to be the candidate list containing one candidate, (s,σ(.,s),R(s)).
c. Compute the binary representation of M, [b₀, . . . , bᵣ₋₁], where b₀, . . . , bᵣ₋₁ can get the values of 0 or 1 and M=b₀2⁰+b₁2¹+ . . . +bᵣ₋₁2^{r-1}.
d. If b₀=1 set S*=S. Else set S* to be an empty sequence

2. For j=1, . . . , r−1, do:
a. If M<2^{j} skip steps b and c.
b. Compute Sⱼ:=(Sⱼ₋₁ΘSⱼ₋₁)_{Q}
c. If bⱼ=1:
   i. If S* is empty set S*:=Sⱼ.
   ii. Else compute S*:=(S*ΘSⱼ₋₁)_{Q}

3. Choose the row indices vector as the row indices vector of the first candidate in S.

In step S340, after the measurement matrix is generated, the measurement matrix is used in compressive sensing. For example, the measurement matrix generated by the measurement matrix generator 207 may be used by any of the compressive sensing methods described in application Ser. Nos. 12/894,855, 12/894,757 12/894,807, ______ [attorney docket No. 29250-002541] and 13/182,856, which are partly described below.

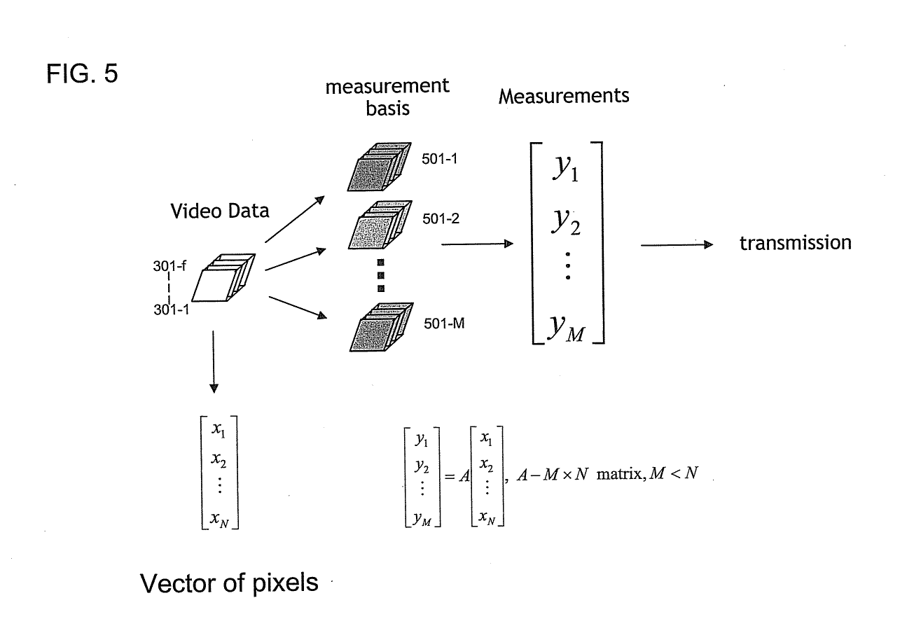

FIG. 5 illustrates a method of encoding the acquired video data using compressive measurements according to an embodiment.

The original video data includes a number of consecutive frames 301-1 to 301-f, where f is the number of frames which may be any integer. Each frame 301 of the video data has size c multiplied by r, where c and r are the numbers of horizontal and vertical pixels in each frame. Also, the video encoder 202 may convert the original video frames 301 into a structure different than the structure of the video frames 301. For instance, the video encoder 202 may form the original video frames 301 into a different temporal structure. For example, the temporal structure may include a sub-block of video data extracted from each frame in a number of consecutive frames. The temporal structure may be one of video cubes or video tubes, as further explained below.

In the case of video cubes, the video encoder 202 extracts a 2-D block of video data from each of the video frames 301 in the number of consecutive frames 301-1 to 301-f. The 2-D non-overlapping block represents a sub-region of each video frame. Each block for each frame 301 may have the same number of pixels and the blocks may be extracted from the same location in each of the consecutive frames 301. The video encoder 202 forms the video cube by stacking each extracted block to form a three dimensional (3-D) video structure. Encoding is performed cube by cube on all video cubes that comprises the received video data.

In the case of video tubes, the video encoder 202 extracts a non-overlapping 2-D block of video data from at least one video frame 301 in a group of pictures (GOP). For example, the video tube includes 2-D blocks extracted from the video frames 301, which may follow the motion trajectory of a particular object in the GOP. The object may be a meaningful object in the video image such as an image of a person as he moves through the video frames 301 of the GOP. Each video tube may include extracted blocks that have different shapes and sizes, and may have different locations within their respective frames. Also, different video tubes may include a different number of frames. The video encoder 202 forms the video tubes by stacking each extracted block to form a 3-D video structure. Encoding is performed tube by tube on all video tubes that comprises the received video data.

The video encoder 202 applies a set of measurement bases to the temporal structure of the video data. For example, the video encoder 202 applies a set of measurement bases 501-1 to 501-M to the video frames 301 to obtain a set of measurements y₁ to y_{M}. The variable M may be any integer greater or equal to 1. Each value of y represents a compressive measurement. A number of measurement bases M applied to the video frames 301 corresponds to a number of measurements M. The set of measurement bases 501-1 to 501-M is a graphical representation of the measurement matrix that was generated by the measurement matrix generator 207. For example, each measurement basis corresponds to a different row in the measurement matrix. As such, the measurement matrix may be used interchangeably with the set of measurement bases. A description of how compressive measurements are calculated is explained below.

First, the video encoder 202 scans the pixels of the video frames 301 to obtain vector xε [symbol] ^{N}, which is a 1-D representation of the video frames 301 comprising the video data, where N=c×r×f is the length of the vector x. The vector x includes the pixel values of the video frames 301, which is arranged as [x₁ x₂ . . . x_{N}]. As shown in FIG. 5, the 1-D representation vector x may be multiplied by measurement matrix A (which is the measurement matrix generated by the measurement matrix generator 207) to obtain the set of measurements y₁ to y_{M}. The length of vector x is N, which is also the number of pixels in the video frames 301. The M compressive measurements of vector x is the vector yε [symbol] ^{M} defined by y=Ax. As previously described, the measurement matrix A has dimension M×N.

The video encoder 202 outputs the set of measurements y₁ to y_{M} to the channel encoder 203. The channel encoder 203 encodes the set of measurements y₁ to y_{M} for transmission to the destination device 103. For example, the measurements are quantized to integers. The quantized measurements are packetized into transmission packets. The transmission sequence including the quantized measurements may also include other information such as the measurement matrix information that identifies the measurement matrix generated by the measurement matrix generator 207 so that the destination device 103 may reconstruct the measurement matrix based on the measurement matrix information. The measurement matrix information may include at least one of information indicating the size of the measurement matrix (e.g., the value of N, and the value of M), information indicating the initial values of the shift register, information indicating the selected primitive polynomial, information indicating a type of shift for the other rows of the measurement matrix (e.g., to the left or the right), and information indicating a type of values for the measurement matrix (e.g., 0/1 or −1/1).

Next, the source device 101 transmits the set of measurements y₁ to y_{M} and the measurement matrix information to the destination device 103 via the communication channel of the network 102. The source device 101 may transmits the measurement matrix information and the set of measurements, as well as other information such as assignment information, for example, in a plurality of datagrams, which is further explained in co-pending application Ser. No. ______ [attorney docket No. 29250-002541].

The channel decoder 204 of the destination device 101 decodes the transmission, and forwards the correctly received measurements and the measurement matrix information to the video decoder 205 in a manner that was previously described above.

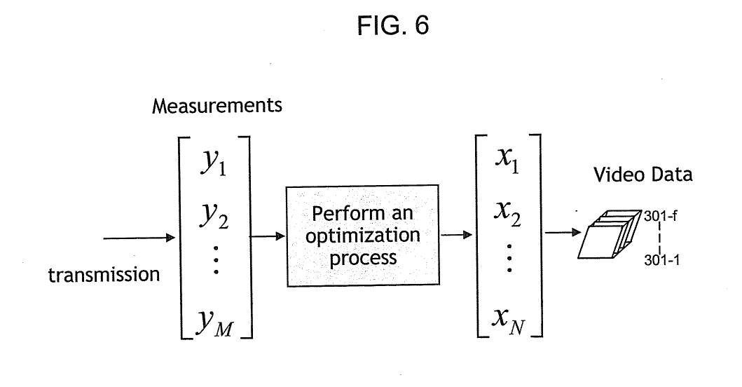

FIG. 6 illustrates a reconstruction process by the video decoder 205 according to an embodiment.

The video decoder 205 performs an optimization process on the correctly received measurements to obtain the vector [x₁ x₂ . . . x_{N}], which is a one dimensional (1-D) representation of the video data 301.

For example, the video decoder 205 obtains a set of values—the vector [x₁ x₂ . . . x_{N}]—by solving one of the following two minimization equations, which represents a minimization problem:

$$\begin{matrix}{min}_{x} {TV}_{2} ( {DCT}_{t} ( x ) ) , subject to y = Ax , or & Equation 1 \\ {min}_{x} {TV}_{2} ( {DCT}_{t} ( x ) ) + \frac{μ}{2} {‖ Ax - y ‖}_{2}^{2} & Equation 2\end{matrix}$$

In both equations, y is the set of available transmitted measurements for one video cube, e.g., y₁ to y_{M}, and A is the measurement matrix representing the set of measurement bases, i.e., 501-1, 501-M, and x is the vector [x₁ x₂ . . . x_{N}], whose components are pixels of the video data. The variable μ is the penalty parameter. The value of the penalty parameter is a design choice. DCTₜ(x) is a 1-D DCT transform in the time domain, and TV₂(z) is a two-dimensional (2-D) total variation (TV) function, where z represents the results of the 1-D DCT function. Equation 2 is an alternative way of expressing Equation 1. The video decoder 205 may implement Equation 1 or Equation 2 according to methods that are well known. This reconstruction process is further detailed in application Ser. No. 12/894,757. Further, the embodiments also encompass any of the reconstruction methods described in application Ser. Nos. 12/894,855, 12/894,807, 13/182,856 and ______ [Attorney Docket No. 29250-002541].

As shown above, the reconstruction process uses the set of measurements y₁ to y_{M} and the measurement matrix A in the above equations to reconstruct the vector [x₁ x₂ . . . x_{N}], whose components are pixels of the video data. To perform such a reconstruction process, the video decoder 205 computes Ax, where A is the measurement matrix, and x is the vector approximating the pixel vector of the video data 301.

In order to perform such a computation, the video decoder 205 requires information to obtain the identity of the measurement matrix. For example, the video decoder 205 obtains the identity of the measurement matrix from the measurement matrix information that was transmitted with the set of measurements. As indicated above, the measurement matrix information may include at least one of information indicating the size of the measurement matrix (e.g., the value of N, and the value of M), information indicating the initial values of the shift register, information indicating the selected primitive polynomial, information indicating a type of shift of the at least one other row, and information indicating a type of value for the measurement matrix. Based on this information, the video decoder 205 obtains sufficient information about the measurement matrix that was applied to the video data at the video encoder 202 to compute Ax in Equation 1 or 2, as further explained below.

A straight forward matrix by vector multiplication to compute Ax requires at least M*N operations. However, because of the special structure of the measurement matrix as described above, the computation of the operation Ax can be performed with a reduced complexity as follows. In order to compute Ax, where A is the M×N (M<N) matrix fowled from shifting the maximum length sequence as illustrated in Table 3, for example, the video decoder 205 extends the measurement matrix A to a square matrix B of dimension N×N. The video decoder 205 obtains the square matrix by adding N−M additional rows to the measurement matrix A. The first M rows of the square matrix B form the measurement matrix A. Starting from the last row of the measurement matrix A, the video decoder 205 obtains the next row of the square matrix B from the last row of the measurement matrix A by an appropriate shift. The video decoder 205 obtains each additional row of the square matrix B from the previous row by an appropriate shift, until the square matrix B has N rows. As an example, if the measurement matrix A is the first four (4) rows of the matrix in Table 3, the measurement matrix A has dimension 4×7. Then, the square matrix B is the 7×7 matrix as shown in Table 3. After the square matrix B is formed from the measurement matrix A, the video decoder 205 computes an intermediate vector z=Bx. It is well known in the art that there are algorithms to compute Bx, where B is the special square matrix previously described. The number of operations to compute B is proportional to N*log(N). After z=Bx is computed, the first M entries in the vector z forms the vector Ax. In other word, let w be the vector whose entries are the first M entries of z, then Ax=w. In summary, the video decoder 205 computes Ax by first computing Bx and then obtaining then first M entries of the result. The complexity of this method is in the order of N*log(N), which is smaller than the complexity of M*N for many applications where log(N)<M.

After the values for the vector [x₁ x₂ . . . x_{N}] are obtained according to the optimization process, the video decoder 205 reconstructs the video data 301 from the vector [x₁ x₂ . . . x_{N}]. For example, if the video data was encoded as video cubes, the video decoder 205 reconstructs the frames of the video data based on the vector [x₁ x₂ . . . x_{N}]. However, the embodiments encompass any type of method that reconstructs video frames (or a particular temporal structure of a video frame such as video cubes or tubes) from a set of values. The destination device 103 displays the reconstructed video data on the video display 206.

Variations of the example embodiments of the present disclosure are not to be regarded as a departure from the spirit and scope of the example embodiments, and all such variations as would be apparent to one skilled in the art are intended to be included within the scope of this disclosure.

What is claimed:

1. A method for encoding video data, the video data being represented by a pixel vector including a number of pixel values, the method including:
generating, by the encoder, a measurement matrix including a first row having a sequence of values and at least one other row having a shifted version of the sequence of values for the first row; and
obtaining, by the encoder, a set of measurements by applying the measurement matrix to the video data, the set of measurements being coded data representing the video data.

2. The method of claim 1, wherein the generating step increases the number of pixel values to include at least one dummy value until the number of pixel values satisfies 2^{K}−1, where K is any positive integer and the generates the sequence of values based on the increased number of pixel values.

3. The method of claim 1, wherein the generating step generates the sequence of values by selecting a polynomial based on the number of pixel values included in the pixel vector and configuring a linear feedback shift register based on the selected polynomial, the sequence of values being generated using the configured feedback shift register.

4. The method of claim 1, wherein the generating step further includes,
generating the measurement matrix to have N rows and N columns, a value of N being related to the length of the pixel vector;
selecting M rows from the N rows based on a figure of merit value for said selected M rows, wherein a value of M corresponds to the number of measurements included in the set and M is less than N.

5. The method of claim 1, further comprising:
transmitting, by the encoder, the set of measurements and measurement matrix information, the measurement matrix information indicating information about the measurement matrix,
wherein the measurement matrix information includes at least one of information indicating a size of the measurement matrix, information indicating initial values of a shift register, information indicating a selected primitive polynomial, information indicating a type of shift of the at least one other row, and information indicating a type of value for the measurement matrix.

6. A method for decoding video data, the method including:
receiving, by an decoder, a set of measurements, the set of measurements being coded data representing video data, the video data being a pixel vector including a number of pixel values;
obtaining, by the decoder, a measurement matrix that was applied to the pixel vector at an encoder, the measurement matrix including a first row having a sequence of values and at least one other row having a shifted version of the sequence of values; and
reconstructing, by the decoder, the video data based on the set of measurements and the obtained measurement matrix.

7. The method of claim 6, wherein the measurement matrix has size M×N, a value of M corresponds to a number of measurements included in the set and a value of N is related to the number of pixel values included in the pixel vector.

8. The method of claim 6, wherein
the receiving step receives measurement matrix information, the measurement matrix information indicating information about the measurement matrix,
the obtaining step obtains the measurement matrix based on the measurement matrix information.

9. The method of claim 8, wherein the measurement matrix information includes at least one of information indicating a size of the measurement matrix, information indicating initial values of a shift register, information indicating a selected primitive polynomial, information indicating a type of shift of the at least one other row, and information indicating a type of value for the measurement matrix.

10. The method of claim 6, wherein the reconstruction step modifies the measurement matrix by adding additional rows to the measurement matrix to form a square matrix, and the reconstruction step reconstructs the video data using the square matrix.

11. An apparatus for encoding video data, the video data being represented by a pixel vector including a number of pixel values, the apparatus including:
an encoder configured to generate a measurement matrix including a first row having a sequence of values and at least one other row having a shifted version of the sequence of values for the first row, and
the encoder configured to obtain a set of measurements by applying the measurement matrix to the video data, the set of measurements being coded data representing the video data.

12. The apparatus of claim 11, wherein the encoder increases the number of pixel values to include at least one dummy value until the number of pixel values satisfies 2^{K}−1, where K is any positive integer and the generates the sequence of values based on the increased number of pixel values.

13. The apparatus of claim 11, wherein the encoder generates the sequence of values by selecting a polynomial based on the number of pixel values included in the pixel vector and configuring a linear feedback shift register based on the selected polynomial, the sequence of values being generated using the configured feedback shift register.

14. The apparatus of claim 11, wherein the encoder is configured to generate the measurement matrix to have N rows and N columns, a value of N being related to the length of the pixel vector, and the encoder is configured to select M rows from the N rows based on a figure of merit value for said selected M rows, wherein a value of M corresponds to the number of measurements included in the set and M is less than N.

15. The apparatus of claim 11, wherein the encoder is configured to transmit the set of measurements and measurement matrix information, the measurement matrix information indicating information about the measurement matrix, wherein the measurement matrix information includes at least one of information indicating a size of the measurement matrix, information indicating initial values of a shift register, information indicating a selected primitive polynomial, information indicating a type of shift of the at least one other row, and information indicating a type of value for the measurement matrix.

16. An apparatus for decoding video data, the apparatus including:
a decoder configured to receive a set of measurements, the set of measurements being coded data representing video data, the video data being a pixel vector including a number of pixel values,
the decoder configured to obtain a measurement matrix that was applied to the pixel vector at an encoder, the measurement matrix including a first row having a sequence of values and at least one other row having a shifted version of the sequence of values, and
the decoder configured to reconstruct the video data based on the set of measurements and the obtained measurement matrix.

17. The apparatus of claim 16, wherein the measurement matrix has size M×N, a value of M corresponds to a number of measurements included in the set and a value of N is related to the number of pixel values included in the pixel vector.

18. The apparatus of claim 16, wherein
the decoder is configured to receive measurement matrix information, the measurement matrix information indicating information about the measurement matrix,
the decoder is configured to obtain the measurement matrix based on the measurement matrix information.

19. The apparatus of claim 18, wherein the measurement matrix information includes at least one of information indicating a size of the measurement matrix, information indicating initial values of a shift register, information indicating a selected primitive polynomial, information indicating a type of shift of the at least one other row, and information indicating a type of value for the measurement matrix.

20. The apparatus of claim 16, wherein the decoder modifies the measurement matrix by adding additional rows to the measurement matrix to form a square matrix, and the decoder reconstructs the video data using the square matrix.
